(19) United States
(12) Patent Application Publication
(10) Pub. No.: US 2026/0205938 A1
(43) Pub. Date: Jul. 16, 2026

(54) COMMUNICATION METHOD AND APPARATUS

(71) Applicant: HUAWEI TECHNOLOGIES CO., LTD., Shenzhen (CN)

(72) Inventors: Ying Chen, Hangzhou (CN); Jiayin Zhang, Shanghai (CN); Xiaolei Tie, Shanghai (CN)

(73) Assignee: HUAWEI TECHNOLOGIES CO., LTD., Shenzhen (CN)

(21) Appl. No.: 19/562,710

(22) Filed: Mar. 10, 2026

Related U.S. Application Data
(63) Continuation of application No. PCT/CN2024/121570, filed on Sep. 26, 2024.

(30) Foreign Application Priority Data
Oct. 12, 2023 (CN) 202311324873.3

(51) Int. Cl. H04W 48/20; H04B 17/318; H04W 64/00; H04W 84/06

(52) U.S. Cl. CPC H04W 48/20; H04B 17/318; H04W 64/006; H04W 84/06

(57) ABSTRACT

Embodiments of this disclosure provide a communication method and apparatus. The method includes: A terminal device determines parameter information, where the parameter information is used to determine whether the terminal device leaves a terrestrial cell set, the terrestrial cell set includes a reference cell, and the reference cell is a terrestrial cell that the terminal device currently camps on or accesses; and the terminal device obtains first communication information when the parameter information meets a first communication condition, where the first communication information is used to select a non-terrestrial cell, and the non-terrestrial cell is a non-terrestrial neighboring cell of the reference cell. In this method, overheads of interpreting communication information by the terminal device can be reduced, and communication efficiency can be improved.

### CROSS-REFERENCE TO RELATED APPLICATIONS

This application is a continuation of International Application No. PCT/CN2024/121570, filed on September 26, 2024, which claims priority to Chinese Patent Application No. 202311324873.3, filed on October 12, 2023. The disclosures of the aforementioned applications are hereby incorporated by reference in their entireties.

### TECHNICAL FIELD

This disclosure relates to the communication field, and in particular, to a communication method and apparatus.

### BACKGROUND

Compared with terrestrial communication, satellite communication has unique advantages. For example, the satellite communication can provide wider coverage areas, and satellite base stations are not vulnerable to natural disasters or external forces. Therefore, it is an inevitable trend of future communication for a terminal device to support the satellite communication and the terrestrial communication (for example, 5G communication), and convergence of the satellite communication and the terrestrial communication requires enhancement to an existing communication protocol to adapt to the satellite communication. In a conventional technical solution, a neighboring cell of a non-terrestrial cell (for example, a satellite cell) needs to transmit (for example, transmit in a broadcast manner) communication information of the non-terrestrial cell, where the communication information is used to select (camp on, reselect, or be handed over to) the non-terrestrial cell, to enhance a communication protocol.

Generally, because communication information used to camp on or access a terrestrial cell is not frequently updated, a terminal device served by the terrestrial cell does not need to frequently obtain communication information of the terrestrial cell. However, based on the foregoing solution, when the neighboring cell of the non-terrestrial cell is a terrestrial cell, because the communication information of the non-terrestrial cell is updated frequently, a device that manages the terrestrial cell needs to frequently transmit the communication information of the non-terrestrial cell. This means that all terminal devices served by the terrestrial cell need to frequently obtain the communication information of the non-terrestrial cell, resulting in excessively high overheads of interpreting the communication information by the terminal device.

### SUMMARY

Embodiments of this disclosure provide a communication method and apparatus, to reduce overheads of interpreting communication information by a terminal device, and improve communication efficiency.

According to a first aspect, an embodiment of this disclosure provides a communication method. The method includes: A terminal device determines parameter information, where the parameter information is used to determine whether the terminal device leaves a terrestrial cell set, the terrestrial cell set includes a reference cell, and the reference cell is a terrestrial cell that the terminal device currently camps on or accesses; and the terminal device obtains first communication information when the parameter information meets a first communication condition, where the first communication information is used to select a non-terrestrial cell, and the non-terrestrial cell is a non-terrestrial neighboring cell of the reference cell.

In this method, the terminal device needs to obtain the first communication information when the parameter information meets the first communication condition. In other words, when the first communication condition is not met, even if the reference cell indicates to the terminal device that the first communication information of the non-terrestrial cell changes, the terminal device may not obtain the first communication information. Therefore, according to the method, the terminal device obtaining and interpreting unnecessary communication information can be avoided, to reduce overheads of interpreting the communication information by the terminal device, and improve communication efficiency.

In a possible design, the terrestrial cell set further includes at least one terrestrial neighboring cell of the reference cell.

In this design, when there is another terrestrial cell around the reference cell, even if the terminal device is located at an edge of the reference cell, the terminal device may select the another terrestrial cell to provide a service for the terminal device. In this case, the terminal device does not need to consider whether the terminal device is located at the edge of the reference cell, and only needs to determine whether the terminal device leaves the terrestrial cell set. Therefore, in this design, a cell range that can be selected by the terminal device can be expanded, and compute resources of the terminal device can be saved.

In a possible design, the terminal device may further obtain threshold information, where threshold information is used to determine the first communication condition. The threshold information includes at least one of the following: a signal strength threshold, where the signal strength threshold is a threshold of signal strength detected by the terminal device; a first distance threshold, where the first distance threshold is a threshold of a distance between the terminal device and a reference location of the terrestrial cell set, and the terrestrial cell set includes the reference cell; a speed threshold, where the speed threshold is a threshold of a movement speed of the terminal device; a coordinate set of a target area, where the target area is determined based on a reference location of the reference cell and a part or all of a coverage area of the non-terrestrial cell, and the target area is in the reference cell; or a second distance threshold, where the second distance threshold is a threshold of a distance between the terminal device and a reference location of the non-terrestrial cell.

Optionally, a manner in which the terminal device may obtain the threshold information may alternatively be as follows: The terminal device receives the threshold information from a network device.

In this design, the terminal device may determine the threshold information, to determine the first communication condition, so as to improve communication efficiency.

In a possible design, the parameter information includes the signal strength detected by the terminal device, and the first communication condition includes: The signal strength is less than or equal to the signal strength threshold.

In this design, when the signal strength detected by the terminal device is less than the signal strength threshold, the terminal device determines that the parameter information meets the first communication condition. In other words, when the signal strength is low, the terminal device is likely to be located at the edge of the reference cell, and therefore the terminal device needs to obtain the first communication information. On the contrary, when the signal strength is high, the terminal device determines that the parameter information does not meet the first communication condition, and may not obtain the first communication information, so that overheads of interpreting the communication information by the terminal device can be reduced, and communication efficiency can be improved.

In a possible design, the parameter information includes a first distance, the first distance is the distance between the terminal device and the reference location of the terrestrial cell set, and the first communication condition includes: The first distance is greater than the first distance threshold.

In this design, when the first distance (that is, the distance between the terminal device and the reference location of the terrestrial cell set) is greater than the first distance threshold, the terminal device determines that the parameter information meets the first communication condition. In other words, when there is another terrestrial cell around the reference cell and the terminal device is located in a coverage area of the another terrestrial cell, the terminal device does not need to obtain communication information of the non-terrestrial cell, so that overheads of interpreting the communication information by the terminal device can be further reduced.

In a possible design, the parameter information includes the movement speed of the terminal device, and the first communication condition includes: The movement speed is greater than the speed threshold.

In this design, when the movement speed of the terminal device is greater than the speed threshold, the terminal device determines that the parameter information meets the first communication condition. In other words, when the terminal device does not move or moves slowly, there is a low probability that the terminal device reaches an edge of the terrestrial cell set in a short period of time, and the terminal device does not need to obtain communication information of the non-terrestrial cell, so that overheads of interpreting the communication information by the terminal device can be further reduced.

In a possible design, the parameter information includes location coordinates of the terminal device, and the first communication condition includes: The location coordinates are in the coordinate set of the target area.

In this design, when the location coordinates of the terminal device are in the target area, the terminal device determines that the parameter information meets the first communication condition. In other words, when the location coordinates of the terminal device are outside the target area, there is a low probability that the terminal device may be located in the non-terrestrial cell or select the non-terrestrial cell, and the terminal device does not need to obtain communication information of the non-terrestrial cell, so that overheads of interpreting the communication information by the terminal device can be further reduced.

In a possible design, the parameter information includes a second distance, the second distance is the distance between the terminal device and the reference location of the non-terrestrial cell, and the first communication condition includes: The second distance is less than the second distance threshold.

In this solution, when the second distance (the distance between the terminal device and the reference location of the non-terrestrial cell) is less than the second distance threshold, the terminal device determines that the parameter information meets the first communication condition. In other words, when the second distance is large, the terminal device cannot select the non-terrestrial cell, and does not need to obtain communication information of the non-terrestrial cell, so that overheads of interpreting the communication information by the terminal device can be further reduced.

In a possible design, the terminal device may obtain the first communication information in the following manner: The terminal device monitors a system message from a first network device when the parameter information meets the first communication condition, where the first network device is a network device that manages the reference cell, and the system message includes the first communication information; or the terminal device sends a distribution request to a second network device when the parameter information meets the first communication condition, and receives a distribution response from the second network device, where the distribution response includes the first communication information.

In this design, the terminal device may obtain the first communication information through the system message, or the terminal device may actively send the distribution request, to obtain the first communication information, so that flexibility of the foregoing communication method can be improved.

In a possible design, a manner in which the terminal device monitors the system message from the first network device may be as follows: The terminal device monitors the system message from the first network device based on a target periodicity when the parameter information meets the first communication condition, where the target periodicity is greater than a sending periodicity of the first communication information.

In this design, the terminal device may set, as the target periodicity, a periodicity of monitoring the first communication information, and the target periodicity is greater than the sending periodicity. In other words, the terminal device does not need to receive each system message sent by the network device. Therefore, overheads of interpreting the communication information by the terminal device can be further reduced.

In a possible design, the terminal device may further receive the sending periodicity of the first communication information.

In this design, the terminal device may determine the sending periodicity of the first communication information, to determine the target periodicity, so as to improve communication efficiency.

According to a second aspect, an embodiment of this disclosure provides a communication method. The method includes: A network device sends threshold information to a terminal device, where the threshold information is used to determine a first communication condition, and the first communication condition is used by the terminal device to determine whether to obtain first communication information; and the network device sends the first communication information, where the first communication information is used to select a non-terrestrial cell, the non-terrestrial cell is a non-terrestrial neighboring cell of a reference cell, and the reference cell is a terrestrial cell that the terminal device currently camps on or accesses.

In a possible design, the threshold information includes at least one of the following: a signal strength threshold, where the signal strength threshold is a threshold of signal strength detected by the terminal device; a first distance threshold, where the first distance threshold is a threshold of a distance between the terminal device and a reference location of a terrestrial cell set, and the terrestrial cell set includes the reference cell; a speed threshold, where the speed threshold is a threshold of a movement speed of the terminal device; a coordinate set of a target area, where the target area is determined based on a reference location of the reference cell and a part or all of a coverage area of the non-terrestrial cell, and the target area is in the reference cell; or a second distance threshold, where the second distance threshold is a threshold of a distance between the terminal device and a reference location of the non-terrestrial cell.

In a possible design, the terrestrial cell set further includes at least one terrestrial neighboring cell of the reference cell.

In a possible design, a manner in which the network device sends the first communication information includes: The network device sends a system message, where the system message includes the first communication information; or the network device receives a distribution request from the terminal device, and sends a distribution response to the terminal device, where the distribution response includes the first communication information.

In a possible design, the network device may further send a sending periodicity of the first communication information to the terminal device, where the sending periodicity is used by the terminal device to determine a target periodicity of monitoring the system message.

According to a third aspect, this disclosure further provides a communication apparatus. The communication apparatus may perform the foregoing method design. The communication apparatus may be a chip or a circuit that can perform functions corresponding to the foregoing method, or a device including the chip or the circuit.

In a possible design, the communication apparatus includes a communication unit, configured to receive and send data; and the communication apparatus further includes a processing unit, configured to implement the steps in the foregoing method. The functions may be implemented by hardware, or may be implemented by hardware executing corresponding software. The hardware or the software includes one or more units corresponding to the foregoing functions.

According to a fourth aspect, this disclosure further provides a communication device. The communication device may perform the foregoing method design. The communication device includes: a memory, configured to store computer-executable program code; and a processor, where the processor is coupled to the memory. The program code stored in the memory includes instructions. When the processor executes the instructions, the communication device or a device in which the communication device is installed is caused to perform the method in any one of the foregoing possible designs.

The communication device may further include a communication interface. Alternatively, if the communication device is a chip or a circuit, the communication interface may be an input/output interface of the chip, for example, an input/output pin.

According to a fifth aspect, this disclosure provides a communication system. The communication system includes one or more apparatuses of the terminal device performing the first aspect and/or the network device performing the second aspect.

According to a sixth aspect, this disclosure provides a computer-readable storage medium. The computer-readable storage medium stores a computer program. When the computer program is run on an apparatus, the method in any one of the foregoing possible designs is performed.

According to a seventh aspect, this disclosure provides a computer program product, where the computer program product stores computer-executable instructions. When the computer-executable instructions are invoked by a computer, the method in any one of the foregoing possible designs is performed.

According to an eighth aspect, this disclosure provides a chip. The chip includes a processor and a memory. The processor is coupled to the memory, and is configured to read a computer program stored in the memory, to perform the method in any one of the foregoing possible designs.

In addition, for technical effects brought by the second aspect to the eighth aspect, refer to the descriptions in the first aspect. Details are not described herein again.

### BRIEF DESCRIPTION OF DRAWINGS

FIG. 1 is a diagram of an architecture of a communication system according to an embodiment of this disclosure;

FIG. 2 is a diagram of a communication disclosure architecture according to an embodiment of this disclosure;

FIG. 3 is a schematic flowchart of a communication method according to an embodiment of this disclosure;

FIG. 4 is a diagram of an example of cell location distribution according to an embodiment of this disclosure;

FIG. 5a is a diagram of an example of an angle range according to an embodiment of this disclosure;

FIG. 5b is a diagram of an example of another angle range according to an embodiment of this disclosure;

FIG. 5c is a diagram of an example of another angle range according to an embodiment of this disclosure;

FIG. 6 is a diagram of a structure of a communication apparatus according to an embodiment of this disclosure; and

FIG. 7 is a diagram of a structure of another communication device according to an embodiment of this disclosure.

### DESCRIPTION OF EMBODIMENTS

To make the objectives, technical solutions, and beneficial effects of this disclosure clearer and more comprehensible, the following further describes this disclosure in detail with reference to the accompanying drawings and embodiments. It should be understood that the embodiments described herein are merely used to explain this disclosure but are not intended to limit this disclosure.

In descriptions of this disclosure, "/" means "or" unless otherwise specified. For example, A/B may indicate A or B. In this disclosure, "and/or" describes only an association relationship for describing associated objects and indicates that three relationships may exist. For example, A and/or B may indicate the following three cases: Only A exists, both A and B exist, and only B exists. In addition, in the descriptions of this disclosure, "at least one item" means one or more items, and "a plurality of items" means two or more items. In descriptions of this disclosure, terms such as "first" and "second" are merely used for differentiated description, and cannot be understood as an indication or implication of relative importance, or cannot be understood as an indication or implication of an order.

The communication method provided in embodiments of this disclosure may be applied to a 4th generation (4G) communication system (for example, long term evolution (LTE)), may be applied to a 5th generation (5G) communication system (for example, 5G new radio (NR)), may be applied to various future evolved communication systems (for example, a 6th generation (6G) communication system), or may be applied to a space-air-sea-ground integrated communication system. The method provided in embodiments of this disclosure may be applied to a terrestrial network communication system, or may be applied to a non-terrestrial network (NTN) communication system.

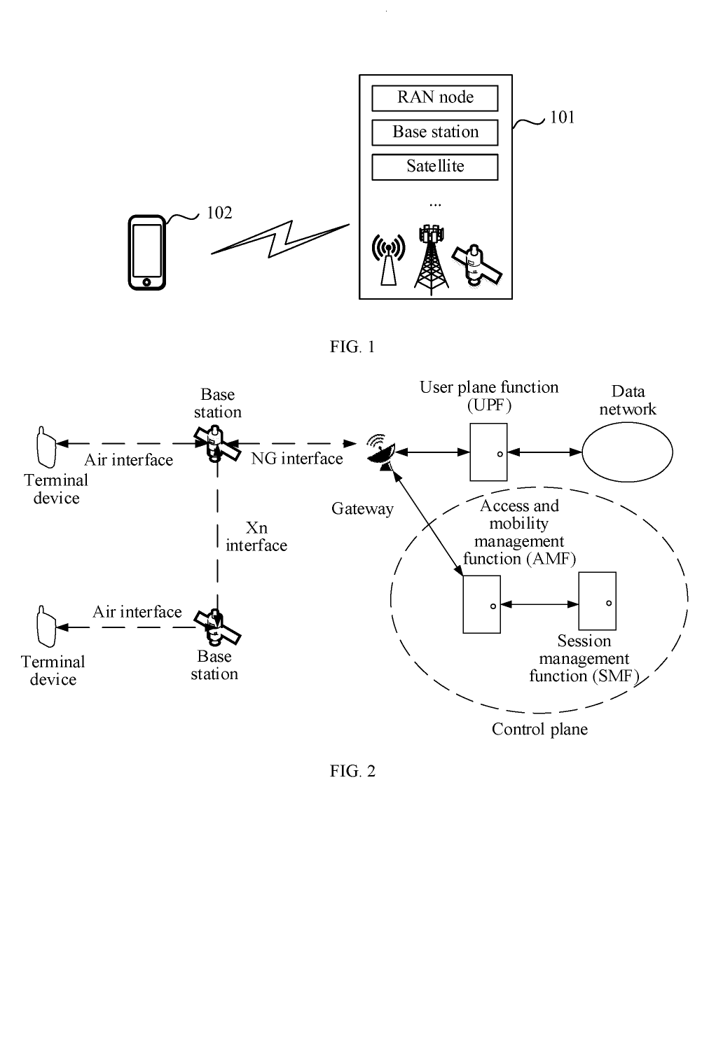

FIG. 1 shows an architecture of a communication system to which an embodiment of this disclosure is applicable. As shown in FIG. 1, a communication system 100 includes a network device 101 and a terminal device 102.

First, possible implementation forms and functions of the network device 101 and the terminal device 102 are described by using an example.

The network device 101 provides a service for the terminal device 102 within a coverage area. For example, as shown in FIG. 1, the network device 101 provides wireless access for one or more terminal devices 102 within the coverage area of the network device 101.

The network device 101 may be a node in a radio access network (RAN), and may also be referred to as a base station, or may be referred to as a RAN node (or device). When the network device 101 is a base station, examples of the base station are: a next generation NodeB (gNB), a next generation evolved NodeB (Ng-eNB), a transmission reception point (TRP), an evolved NodeB (eNB), a radio network controller (RNC), a NodeB (NB), a base station controller (BSC), a base transceiver station (BTS), a home NodeB (for example, a home evolved NodeB or a home NodeB, HNB), a baseband unit (BBU), or a wireless fidelity (Wi-Fi) access point (AP).

The network device 101 may alternatively be a module or unit that completes a part of functions of the base station. For example, the network device 101 may be a central unit (CU), or may be a distributed unit (DU). The CU herein completes functions of a radio resource control protocol and a packet data convergence protocol (PDCP) of the base station, and may further complete a function of a service data adaptation protocol (SDAP). The DU completes functions of a radio link control layer and a medium access control (MAC) layer of the base station, and may further complete a part or all of functions of a physical layer. For detailed descriptions of the foregoing protocol layers, refer to technical specifications related to the 3rd generation partnership project (3GPP).

The network device 101 may alternatively be a satellite, and the satellite may also be referred to as a high-altitude platform, a high-altitude aircraft, or a satellite base station. The network device 101 may alternatively be another device that has a function of the network device. For example, the network device 101 may alternatively be a device that operates as the network device in device-to-device (D2D) communication, and vehicle-to-everything or machine-to-machine (M2M) communication. The network device 101 may alternatively be any possible network device in a future communication system. In embodiments of this disclosure, the function of the network device 101 may alternatively be performed by a module (for example, a chip) in the network device, or may be performed by a control subsystem that includes the function of the network device. The control subsystem including the function of the network device herein may be a control center in the foregoing application scenarios such as a smart grid, industrial control, intelligent transportation, and a smart city.

The terminal device 102 is also referred to as user equipment (UE), a mobile station (MS), a mobile terminal (MT), or the like, and is a device that provides a user with voice and/or data connectivity. For example, the terminal device 102 includes a handheld device, a vehicle-mounted device, or the like that has a wireless connection function. Currently, the terminal device 102 may be: a mobile phone, a tablet computer, a notebook computer, a palmtop computer, a mobile internet device (MID), a wearable device (for example, a smartwatch, a smart band, or a pedometer), a vehicle-mounted device (for example, a car, a bicycle, an electric car, an airplane, a ship, a train, or a high-speed train), a virtual reality (VR) device, an augmented reality (AR) device, a wireless terminal in industrial control, a smart home device (for example, a refrigerator, a television, an air conditioner, or a meter), an intelligent robot, a workshop device, a wireless terminal in self driving, a wireless terminal in remote medical surgery, a wireless terminal in a smart grid, a wireless terminal in transportation safety, a wireless terminal in a smart city, a wireless terminal in a smart home, a flight device (for example, an intelligent robot, a hot air balloon, an uncrewed aerial vehicle, or an airplane), or the like.

The terminal device 102 may alternatively be another device that has a function of the terminal device. For example, the terminal device 102 may alternatively be a device that operates as the terminal device in device-to-device (D2D) communication, vehicle-to-everything or machine-to-machine (M2M) communication. In particular, when communication is performed between network devices, a network device that operates as a terminal device may also be considered as a terminal device. The method provided in embodiments of this disclosure may be performed by a terminal device, or may be performed by a component (for example, a processor, a chip, or a chip system) of the terminal device.

FIG. 2 shows an application architecture according to this disclosure. A terminal device may access a network through an air interface (where the air interface may be an air interface of various types). A base station is deployed on the ground or a satellite, and is connected to a terrestrial core network (not shown in the figure, where the core network includes a user plane and a control plane) via a radio link. There is a radio link (for example, an Xn interface) between satellites, and the radio link may be used for signaling exchange and user data transmission between base stations. Devices and interfaces in FIG. 2 are described as follows.

Core network: The core network provides services such as user access control, mobility management, session management, user security authentication, and charging. The core network includes a plurality of functional units, which may be classified into a control plane functional entity and a user plane functional entity. The control plane includes an access and mobility management function (AMF) unit and a session management function (SMF) unit. The AMF unit is responsible for user access management, security authentication, and mobility management. The user plane includes a user plane function (UPF) unit. The UPF unit is responsible for functions such as user plane data transmission, traffic statistics, and security monitoring.

Gateway: The gateway is responsible for forwarding signaling and service data between a satellite base station and the core network.

Air interface: The air interface is a radio link between a terminal device and a base station. For example, the air interface may be a 5G air interface, and the 5G air interface is a radio link between the terminal device and a 5G base station.

Xn interface: The Xn interface is an interface between base stations, and is mainly used for signaling exchange such as handover.

NG interface: The NG interface is an interface between the base station and the core network, and is mainly for exchanging signaling such as NAS of the core network and service data of a user.

Terminal device: The terminal device is a mobile device that supports new radio. The terminal device may access a satellite network through an air interface and initiate services such as a call and internet access. For example, the terminal device may be considered as the terminal device 102 included in the communication system 100.

Base station: The base station provides a wireless access service, schedules a radio resource to an accessing terminal device, and provides a reliable wireless transmission protocol and data encryption protocol, and the like. For example, the base station may be considered as the network device 101 included in the communication system 100, or an apparatus (for example, a chip system, where the apparatus may be installed in the network device 101) configured to implement a function of the network device.

To reduce overheads of interpreting communication information by a terminal device and improve communication efficiency, embodiments of this disclosure provide a communication method. The communication method may be implemented in the communication system shown in FIG. 1, and the communication method may be further applied to the application architecture shown in FIG. 2. The following describes, with reference to the accompanying drawings, the communication method provided in embodiments of this disclosure.

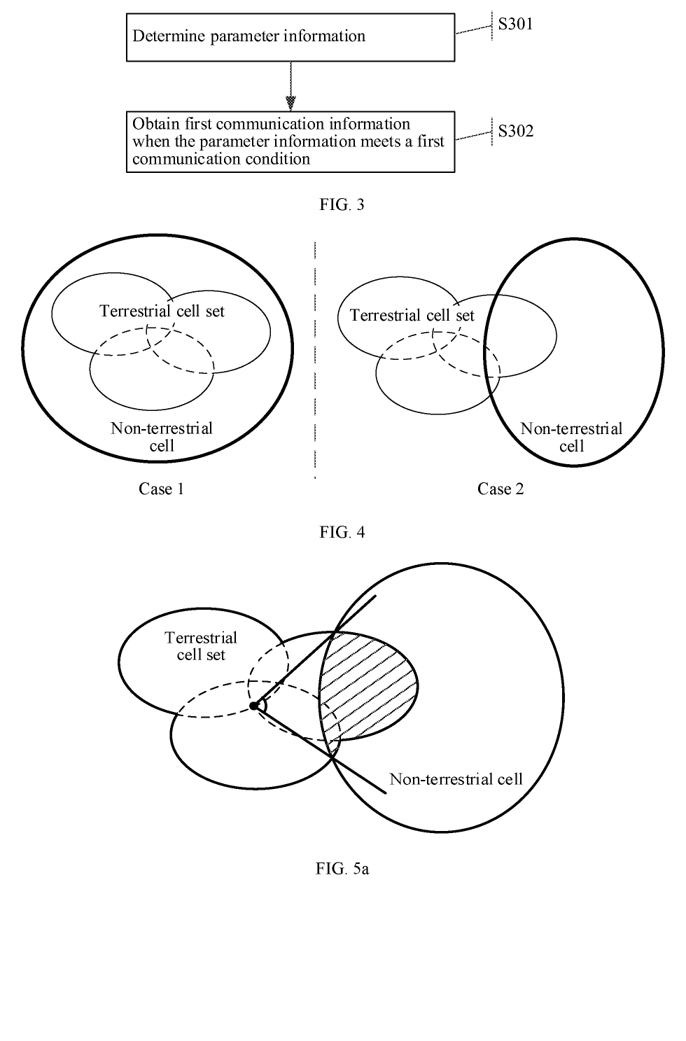

FIG. 3 shows a communication method according to an embodiment of this disclosure. The method may include the following steps.

S301. A terminal device determines parameter information, where the parameter information is used to determine whether the terminal device leaves a terrestrial cell set, the terrestrial cell set includes a reference cell, and the reference cell is a terrestrial cell that the terminal device currently camps on or accesses. It should be understood that the terminal device may be the terminal device 102 in the communication system shown in FIG. 1, or may be the terminal device in the application architecture shown in FIG. 2.

Optionally, the terrestrial cell set further includes at least one terrestrial neighboring cell of the reference cell. In other words, the terrestrial cell set may include the reference cell and another terrestrial cell. In this way, when there is another terrestrial cell around the reference cell, even if the terminal device is located at an edge of the reference cell, the terminal device may select the another terrestrial cell to provide a service for the terminal device. This expands a cell range that can be selected by the terminal device. Therefore, the terminal device does not need to consider whether the terminal device is located at the edge of the reference cell, and only needs to determine whether the terminal device is located at an edge of the terrestrial cell set, to save compute resources of the terminal device.

Optionally, the parameter information may include at least one of the following: signal strength detected by the terminal device; a first distance, where the first distance is a distance between the terminal device and a reference location of the terrestrial cell set; a movement speed of the terminal device; location coordinates of the terminal device; a second distance, where the second distance is a distance between the terminal device and a reference location of a non-terrestrial cell (for example, a satellite cell); and a movement direction of the terminal device.

It should be noted that the terrestrial cell is an area covered by a ground base station, and correspondingly, the terrestrial cell set is an area covered by at least one ground base station. In this embodiment of this disclosure, determining whether the terminal device leaves the terrestrial cell set is determining whether the terminal device is located at the edge of the terrestrial cell set, or determining whether a probability that the terminal device leaves a current terrestrial cell set is high. In other words, in this embodiment of this disclosure, the parameter information is used to determine whether the terminal device is located at the edge of the terrestrial cell set.

S302. The terminal device obtains first communication information when the parameter information meets a first communication condition, where the first communication information is used to select a non-terrestrial cell, and the non-terrestrial cell is a non-terrestrial neighboring cell of the reference cell.

Optionally, the non-terrestrial cell may be a satellite cell (a cell managed by a satellite base station).

Optionally, the first communication information indicates information about the non-terrestrial cell, for example, ephemeris information of the non-terrestrial cell, valid duration of the ephemeris information, an orbital altitude of a management device (for example, the satellite base station) of the non-terrestrial cell, or a common timing advance (TA) corresponding to the non-terrestrial cell. The valid duration of the ephemeris information indicates that, within a period of time (valid duration) after a reference time (a preset time point), the terminal device may continue to use the current ephemeris information. In other words, within the valid duration, the terminal device does not need to obtain new ephemeris information, and an error of the ephemeris information is ensured to be within an allowed range. The TA corresponding to the non-terrestrial cell indicates a TA of an uplink signal sent by the terminal device to the non-terrestrial cell.

Optionally, in this embodiment of this disclosure, there is any one of the following cases for selecting the non-terrestrial cell: camping on the non-terrestrial cell, reselecting the non-terrestrial cell, or being handed over to the non-terrestrial cell.

Optionally, after the terminal device obtains the first communication information, the terminal device may select the non-terrestrial cell; or after the terminal device obtains the first communication information, the terminal device may select another non-terrestrial cell (the terminal device may store second communication information of the another non-terrestrial cell in advance); or after the terminal device obtains the first communication information, the terminal device may not select any non-terrestrial cell. This is not limited in this disclosure.

Optionally, a relationship between a coverage area of the terrestrial cell set and a coverage area of the non-terrestrial cell may be full overlapping or partial overlapping. This is not limited in this disclosure. For example, as shown in FIG. 4, an application process of the communication method includes but is not limited to the following two cases:

Case 1: The coverage area of the non-terrestrial cell includes the coverage area of the terrestrial cell set.

Case 2: The coverage area of the non-terrestrial cell partially overlaps with the coverage area of the terrestrial cell set.

In a possible design before step S302 is performed, the terminal device may obtain threshold information. The threshold information is used to determine a first communication condition, and the first communication condition is used by the terminal device to determine whether to obtain the first communication information.

Optionally, the threshold information includes at least one of the following: a signal strength threshold, where the signal strength threshold is a threshold of signal strength detected by the terminal device; a first distance threshold, where the first distance threshold is a threshold of a distance between the terminal device and a reference location of the terrestrial cell set, and the terrestrial cell set includes the reference cell; a speed threshold, where the speed threshold is a threshold of a movement speed of the terminal device; a coordinate set of a target area, where the target area is determined based on a reference location of the reference cell and a part or all of the coverage area of the non-terrestrial cell, and the target area is in the reference cell; a second distance threshold, where the second distance threshold is a threshold of a distance between the terminal device and a reference location of the non-terrestrial cell; a first angle range, where a first angle is determined based on the reference location of the non-terrestrial cell and a cell overlapping area, and the cell overlapping area is an overlapping area between the coverage area of the non-terrestrial cell and the coverage area of the terrestrial cell set; or a second angle range, where a second angle is determined based on the reference location of the terrestrial cell set and a cell overlapping area, and the cell overlapping area is an overlapping area between the coverage area of the non-terrestrial cell and the coverage area of the terrestrial cell set.

Optionally, manners in which the terminal device obtains the threshold information include the following manner A and manner B.

Manner A: A network device sends the threshold information to the terminal device. Correspondingly, the terminal device receives the threshold information. It should be understood that the network device may be the network device 101 in the communication system shown in FIG. 1, or may be the base station in the application architecture shown in FIG. 2.

Manner B: The terminal device may preconfigure the threshold information.

In the communication method shown in step S301 and step S302, the terminal device obtains the first communication information when the parameter information meets the first communication condition. In other words, when the first communication condition is not met, even if the reference cell indicates to the terminal device that the first communication information of the non-terrestrial cell changes, the terminal device may not obtain the first communication information. The terminal device obtaining and interpreting unnecessary communication information can be avoided. In addition, the first communication information may be used to select the non-terrestrial cell, so that service continuity of the terminal device can be ensured. Therefore, according to the foregoing communication method, overheads of interpreting the communication information by the terminal device can be reduced, and communication efficiency can be improved.

Based on the foregoing design, the terminal device may further determine whether the parameter information meets the first communication condition. The determining process may be implemented with reference to one or more of the following eight solutions.

Solution 1: The parameter information includes the signal strength detected by the terminal device, and the first communication condition includes: The signal strength is less than or equal to the signal strength threshold.

Optionally, the network device sends the threshold information (including the signal strength threshold) to the terminal device. Correspondingly, the terminal device receives the threshold information.

In this solution, when the signal strength detected by the terminal device is less than the signal strength threshold, the terminal device determines that the parameter information meets the first communication condition. It may be understood that when the signal strength is low, the terminal device is likely to be located at the edge of the reference cell. Therefore, the terminal device needs to obtain the first communication information, so that the terminal device can select the non-terrestrial cell, to ensure service continuity of the terminal device.

Solution 2: The parameter information includes the first distance, the first distance is the distance between the terminal device and the reference location of the terrestrial cell set, and the first communication condition includes: The first distance is greater than the first distance threshold.

Optionally, the network device sends the threshold information (including the first distance threshold) to the terminal device. Correspondingly, the terminal device receives the threshold information.

In this solution, because the coverage area of the terrestrial cell set is greater than or equal to a range of the reference cell, and terrestrial cells in the terrestrial cell set differ in quantity and distribution pattern, a value of the first distance threshold may be determined based on the coverage area of the terrestrial cell set and the distribution rules of the terrestrial cells in the terrestrial cell set. This is not limited in this disclosure. For example, when the terrestrial cell set includes only the reference cell, the value of the first distance threshold is small.

Optionally, the terminal device may further obtain the reference location of the terrestrial cell set.

In this solution, when the terrestrial cell set includes only the reference cell, the reference location of the terrestrial cell set may be the reference location of the reference cell.

In this solution, when the first distance (that is, the distance between the terminal device and the reference location of the terrestrial cell set) is greater than the first distance threshold, the terminal device determines that the parameter information meets the first communication condition. It may be understood that when there is another terrestrial cell around the reference cell and the terminal device is located in a coverage area of the another terrestrial cell, the terminal device does not need to obtain communication information of the non-terrestrial cell, so that overheads of interpreting the communication information by the terminal device can be further reduced. When the first distance is large, the terminal device may be located at the edge of the terrestrial cell set, and the terminal device needs to obtain the first communication information, so that the terminal device can select the non-terrestrial cell, to ensure service continuity of the terminal device.

Solution 3: The parameter information includes the movement speed of the terminal device, and the first communication condition includes: The movement speed is greater than the speed threshold.

Optionally, the network device sends the threshold information (including the speed threshold) to the terminal device. Correspondingly, the terminal device may further receive the threshold information.

Optionally, the speed threshold may be 0.

In this solution, when the movement speed of the terminal device is greater than the speed threshold, the terminal device determines that the parameter information meets the first communication condition. It may be understood that when the terminal device does not move or moves slowly, there is a low probability that the terminal device reaches the edge of the terrestrial cell set in a short period of time, and the terminal device does not need to obtain communication information of the non-terrestrial cell, so that overheads of interpreting the communication information by the terminal device can be further reduced. When the movement speed of the terminal device is high, the terminal device may reach the edge of the terrestrial cell set in a short period of time, or even exceed the coverage area of the terrestrial cell set, and the terminal device needs to obtain the first communication information, so that the terminal device can select the non-terrestrial cell, to ensure service continuity of the terminal device.

Solution 4: The parameter information includes the location coordinates of the terminal device, and the first communication condition includes: The location coordinates are in the coordinate set of the target area.

Optionally, the network device sends the threshold information (including the coordinate set of the target area) to the terminal device. Correspondingly, the terminal device may further receive the threshold information.

Optionally, the target area may be an area that is in the terrestrial cell set and that is close to the non-terrestrial cell. This is not limited in this disclosure. It is assumed that the relationship between the coverage area of the terrestrial cell set and the coverage area of the non-terrestrial cell corresponds to the case 2 shown in FIG. 4. When the terminal device moves to an edge of a left part of the terrestrial cell set, the terminal device is far away from the non-terrestrial cell, making it difficult to move to the coverage area of the non-terrestrial cell in a short period of time. Therefore, even if the terminal device cannot implement service processing through the terrestrial cell set, the terminal device cannot select the non-terrestrial cell to provide a service processing capability, and does not need to obtain communication information of the non-terrestrial cell. Therefore, in the foregoing solution, overheads of interpreting communication information by the terminal device can be further reduced.

In this solution, when the location coordinates of the terminal device are in the target area, the terminal device determines that the parameter information meets the first communication condition. When the terminal device is located at the edge of the terrestrial cell set and may select the non-terrestrial cell, the terminal device needs to obtain the first communication information, so that the terminal device can select the non-terrestrial cell, to ensure service continuity of the terminal device.

Solution 5: The parameter information includes the second distance, the second distance is the distance between the terminal device and the reference location of the non-terrestrial cell, and the first communication condition includes: The second distance is less than the second distance threshold. Optionally, the first communication condition further includes: The second distance is greater than a third distance threshold.

Optionally, the network device sends the threshold information (including the second distance threshold) to the terminal device. Correspondingly, the terminal device may further receive the threshold information. The threshold information may further include the third distance threshold.

Optionally, the terminal device may further obtain the reference location of the non-terrestrial cell.

In this solution, when the second distance (the distance between the terminal device and the reference location of the non-terrestrial cell) is less than the second distance threshold, the terminal device determines that the parameter information meets the first communication condition. It may be understood that when the second distance is large, the terminal device cannot select the non-terrestrial cell, and does not need to obtain communication information of the non-terrestrial cell, so that overheads of interpreting the communication information by the terminal device can be further reduced. When the second distance is small, the terminal device may select the non-terrestrial cell, and the terminal device needs to obtain the first communication information, to ensure service continuity of the terminal device.

Solution 6: The parameter information includes the movement direction of the terminal device, and the first communication condition includes: The movement direction does not fall within the first angle range, and/or the movement direction falls within the second angle range.

Optionally, the network device may send the first angle and/or the second angle to the terminal device. Correspondingly, the terminal device may obtain the first angle and/or the second angle.

Optionally, the network device sends the threshold information (including the first angle range and/or the second angle range) to the terminal device. Correspondingly, the terminal device may further receive the threshold information.

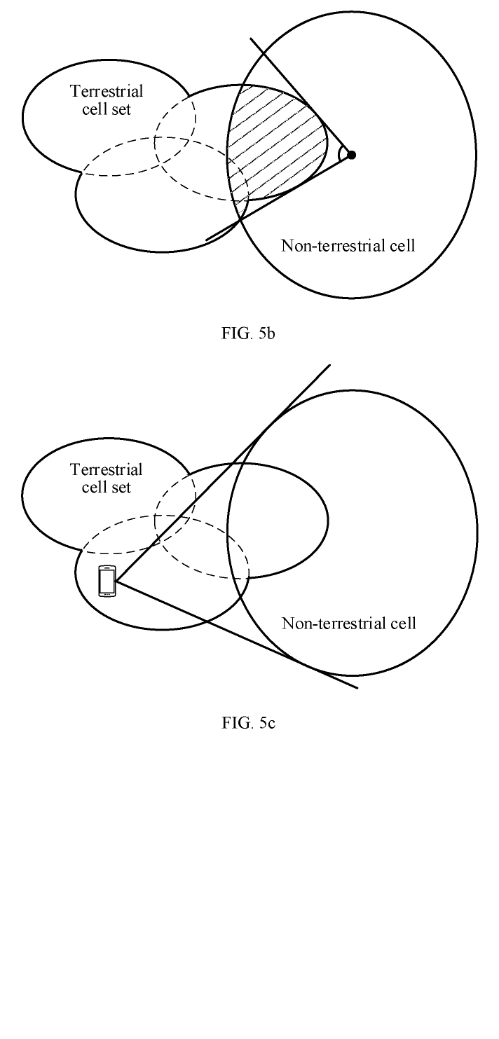

In a possible example, as shown in FIG. 5a, a shaded part is a cell overlapping area, and the first angle range is an angle formed by using the reference location of the terrestrial cell set as a vertex and using lines connecting the vertex to intersection points of the cell overlapping area (or lines from the vertex that are tangent to the cell overlapping area) as edges. A range marked by an arc in the figure is the first angle range.

In another possible example, as shown in FIG. 5b, a shaded part is a cell overlapping area, and the second angle range is an angle formed by using the reference location of the non-terrestrial cell as a vertex and using lines connecting the vertex to intersection points of the cell overlapping area (or lines from the vertex that are tangent to the cell overlapping area) as edges. A range marked by an arc in the figure is the second angle range.

In this solution, in a scenario in which the terrestrial cell set partially overlaps with the non-terrestrial cell, when the movement direction of the terminal device does not fall within the first angle range or falls within the second angle range, the terminal device determines that the parameter information meets the first communication condition. It may be understood that when the movement direction of the terminal device is within a specific range (for example, a direction away from the non-terrestrial cell), the terminal device cannot select the non-terrestrial cell, and does not need to obtain communication information of the non-terrestrial cell, so that overheads of interpreting the communication information by the terminal device can be further reduced. When the movement direction of the terminal device is within a specific range, the terminal device may select the non-terrestrial cell, and the terminal device needs to obtain the first communication information, to ensure service continuity of the terminal device.

Solution 7: The parameter information includes the movement direction of the terminal device, and the first communication condition includes: The movement direction falls within a third angle range.

The terminal device may obtain the location coordinates of the terminal device, and determine the third angle range based on the location coordinates.

In a possible example, as shown in FIG. 5c, the third angle range is an angle formed by using the location coordinates of the terminal device as a vertex and using lines from the vertex that are tangent to the coverage area of the non-terrestrial cell as edges. A range marked by an arc in the figure is the third angle range.

In this solution, in a scenario in which the terrestrial cell set partially overlaps with the non-terrestrial cell, when the movement direction of the terminal device falls within the third angle range, the terminal device determines that the parameter information meets the first communication condition. It may be understood that when the movement direction of the terminal device is within a specific range (for example, a direction away from the non-terrestrial cell), the terminal device cannot select the non-terrestrial cell, and does not need to obtain communication information of the non-terrestrial cell, so that overheads of interpreting the communication information by the terminal device can be further reduced. When the movement direction of the terminal device is within a specific range, the terminal device may select the non-terrestrial cell, and the terminal device needs to obtain the first communication information, to ensure service continuity of the terminal device.

Solution 8: The parameter information includes a decrease rate of signal strength detected by the terminal device (within a preset time period), and the first communication condition includes: The decrease rate of the signal strength is greater than or equal to a signal decrease rate threshold.

Optionally, the network device may send the signal decrease rate threshold to the terminal device. Correspondingly, the terminal device may obtain the signal decrease rate threshold.

In this solution, when the decrease rate of the signal strength of the terminal device is greater than or equal to the signal decrease rate threshold, the terminal device determines that the parameter information meets the first communication condition. It may be understood that when the decrease rate of the signal strength detected by the terminal device is low, current communication of the terminal device is stable, and the terminal device does not need to obtain communication information of the non-terrestrial cell, so that overheads of interpreting the communication information by the terminal device can be further reduced. When the decrease rate of the signal strength detected by the terminal device is high, the terminal device may select the non-terrestrial cell, and the terminal device needs to obtain the first communication information, to ensure service continuity of the terminal device.

Based on the eight solutions provided in the foregoing designs, the process in which the terminal device determines whether the parameter information meets the first communication condition may be implemented with reference to one or more of the foregoing eight solutions. An implementation process includes but is not limited to the following examples.

Example 1: When the designs of the foregoing solution 1 and the foregoing solution 3 are both met, the terminal device determines that the parameter information meets the first communication condition. For example, the first communication condition includes: The signal strength detected by the terminal device is less than or equal to the signal strength threshold, and the movement speed of the terminal device is greater than the speed threshold (for example, 0).

When the movement speed is 0, even if the terminal device meets the condition that "the signal strength is less than or equal to the signal strength threshold", the terminal device does not consider that the parameter information meets the first communication condition. It may be understood that when the terminal device is in a static state (a stable state), even if the terminal device is located at the edge of the terrestrial cell set, the terminal device can still implement a service processing function through the terrestrial cell set, and does not need to obtain communication information of the non-terrestrial cell, so that overheads of interpreting communication information by the terminal device can be further reduced.

Example 2: When the designs of the foregoing solution 2 and the foregoing solution 3 are both met, the terminal device determines that the parameter information meets the first communication condition. For example, the first communication condition includes: The distance (that is, the first distance) between the terminal device and the reference location of the terrestrial cell set is greater than the first distance threshold, and the movement speed of the terminal device is greater than the speed threshold (for example, 0).

When the movement speed is 0, even if the terminal device meets the condition that "the first distance is greater than the first distance threshold", the terminal device does not consider that the parameter information meets the first communication condition. It may be understood that when the terminal device is in a static state (a stable state), even if the terminal device is located at the edge of the terrestrial cell set, the terminal device can still implement a service processing function through the terrestrial cell set, and does not need to obtain communication information of the non-terrestrial cell, so that overheads of interpreting communication information by the terminal device can be further reduced.

Example 3: When the designs of the foregoing solution 2, the foregoing solution 3, and the foregoing solution 5 are all met, the terminal device determines that the parameter information meets the first communication condition. For example, the first communication condition includes: The distance (that is, the first distance) between the terminal device and the reference location of the terrestrial cell set is greater than the first distance threshold, the movement speed of the terminal device is greater than the speed threshold (for example, 0), and the distance (that is, the second distance) between the terminal device and the reference location of the non-terrestrial cell is less than the second distance threshold.

When the movement speed is 0, even if the terminal device meets the condition that "the first distance is greater than the first distance threshold and the second distance is less than the second distance threshold", the terminal device does not consider that the parameter information meets the first communication condition. It may be understood that when the terminal device is in a static state (a stable state), even if the terminal device is located at the edge of the terrestrial cell set, the terminal device can still implement a service processing function through the terrestrial cell set, and does not need to obtain communication information of the non-terrestrial cell. Similarly, when the parameter information does not meet the condition that "the second distance is less than the second distance threshold", even if the terminal device is located at the edge of the terrestrial cell set or even leaves the terrestrial cell set, the terminal device cannot select the non-terrestrial cell, and does not need to obtain communication information of the non-terrestrial cell. Therefore, based on the solution combination of the example 3, overheads of interpreting the communication information by the terminal device can be further reduced.

Example 4: When the designs of the foregoing solution 5 and the foregoing solution 6 are both met, the terminal device determines that the parameter information meets the first communication condition. For example, the first communication condition includes: The distance (that is, the second distance) between the terminal device and the reference location of the non-terrestrial cell is less than the second distance threshold, and the movement direction of the terminal device does not fall within the first angle range. For another example, the first communication condition includes: The distance (that is, the second distance) between the terminal device and the reference location of the non-terrestrial cell is less than the second distance threshold, and the movement direction of the terminal device falls within the second angle range.

Even if the terminal device meets the condition that "the movement direction of the terminal device does not fall within the first angle range" or the condition that "the movement direction of the terminal device falls within the second angle range", if the terminal device is far away from the reference location of the non-terrestrial cell, the terminal device cannot select the non-terrestrial cell in a short period of time, and does not need to obtain communication information of the non-terrestrial cell, so that overheads of interpreting the communication information by the terminal device can be further reduced.

In a possible design, the network device may send the first communication information in a broadcast or unicast manner. The two manners are explained and described below.

Manner 1 (sending in the broadcast manner): The network device (for example, a first network device) sends a system message, where the system message includes the first communication information; and correspondingly, all devices within a range of a cell (for example, a reference cell) managed by the network device may receive the system message. The terminal device monitors the system message when the parameter information meets the first communication condition. In other words, the terminal device may not monitor the system message when the parameter information does not meet the first communication condition, so that communication overheads can be reduced.

Optionally, the terminal device may monitor the system message based on a target periodicity when the parameter information meets the first communication condition, where the target periodicity is greater than a sending periodicity of the first communication information. The target periodicity may be determined by the terminal device, may be a specified periodicity indicated by the network device, or may be a protocol periodicity of the terminal device. This is not limited in this disclosure. It should be understood that the protocol periodicity may be a periodicity jointly agreed on by the terminal device and another device.

The following describes examples of implementation processes in which the terminal device determines the target periodicity.

Example 1: The network device (for example, the first network device) may send the sending periodicity of the first communication information to the terminal device. The sending periodicity is used by the terminal device to determine the target periodicity of monitoring the system message. Correspondingly, the terminal device may receive the sending periodicity of the first communication information. After obtaining the sending periodicity, the terminal device may further determine the target periodicity based on the sending periodicity.

Example 2: After determining the protocol periodicity, the terminal device may further determine the target periodicity based on the protocol periodicity, where the target periodicity is greater than the protocol periodicity of the terminal device and is greater than the sending periodicity of the first communication information.

Example 3: The terminal device obtains valid duration of ephemeris information of the non-terrestrial cell, and determines the target periodicity based on the valid duration.

It should be understood that implementations are not limited to the foregoing three examples, and the terminal device may determine the target periodicity with reference to the solutions in the foregoing three examples. This is not limited in this disclosure.

Optionally, when the parameter information does not meet the first communication condition, the terminal device may not monitor the system message or may monitor the system message based on a preset maximum periodicity, where the maximum periodicity is greater than the sending periodicity of the first communication information.

For example, it is assumed that the sending periodicity of the network device for the first communication information is five system frames. The terminal device may monitor the system message once at an interval of 10 system frames (that is, the target periodicity) when the parameter information meets the first communication condition. The terminal device may not monitor the system message or may monitor the system message once at an interval of 20 system frames (that is, the maximum periodicity) when the parameter information does not meet the first communication condition.

Optionally, when the parameter information does not meet the first communication condition, the terminal device may monitor the system message based on the target periodicity in a sparse monitoring manner, that is, skip monitoring tasks corresponding to some target monitoring periodicities.

For example, assuming that when the parameter information does not meet the first communication condition, the maximum periodicity preset by the terminal device is 20 system frames, the terminal device may monitor the system message in any one or more of a 20^{th} system frame, a 40^{th} system frame, a 60^{th} system frame, and an 80^{th} system frame. For example, the terminal device may skip the 20^{th} system frame and the 40^{th} system frame, and monitor the system message only once in the 60^{th} system frame.

Manner 2 (sending in the unicast manner): The terminal device sends a distribution request to the network device (for example, a second network device) when the parameter information meets the first communication condition; in response to the distribution request, the network device sends a distribution response to the terminal device, where the distribution response includes the first communication information; and correspondingly, the terminal device receives the distribution response from the network device (for example, the second network device).

In a possible example, the network device may deliver communication information based on a combination of the manner 1 and the manner 2. Specifically, the network device may split the first communication information into two parts: second communication information and third communication information. An update frequency of the second communication information is less than an update frequency of the third communication information. For example, an orbital altitude of a management device (for example, a satellite base station) of the non-terrestrial cell has a low update frequency, and therefore may be included in the second communication information.

For example, the network device sends the system message in the broadcast manner, where the system message carries the second communication information. Refer to the foregoing communication method. When determining that the parameter information meets the first communication information, the terminal device sends the distribution request to the network device. When receiving the distribution request, the network device sends the distribution response to the terminal device in the unicast manner, where the distribution response includes the third communication information. Optionally, after the network device determines the second communication information, the network device may further determine the third communication information based on the first communication information and the second communication information through differential calculation.

In this example, the update frequency of the second communication information is low, and correspondingly, the terminal device does not need to frequently interpret the system message. For the third communication information with a high update frequency, the terminal device may actively select a case in which the third communication information is obtained. Therefore, overheads of interpreting the communication information by the terminal device can be further reduced, and communication efficiency can be improved.

The method provided in embodiments of this disclosure is described above with reference to the accompanying drawings. Communication apparatuses provided in embodiments of this disclosure are described below with reference to the accompanying drawings.

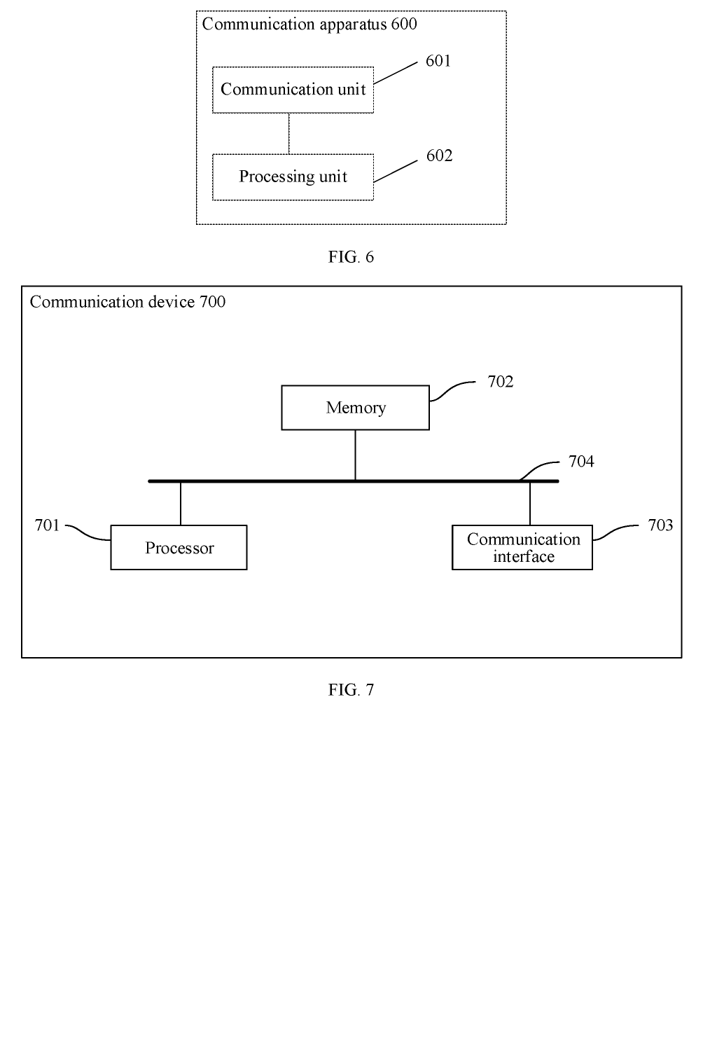

Based on a same technical concept, this disclosure further provides a communication apparatus. The communication apparatus is configured to implement the communication method provided in the foregoing embodiments. Refer to FIG. 6. A communication apparatus 600 includes a communication unit 601 and a processing unit 602. The communication unit 601 is configured to receive and send data. The processing unit 602 is configured to implement the steps in the communication method shown in FIG. 3.

In a possible example, the processing unit 602 is configured to determine parameter information, where the parameter information is used to determine whether a terminal device leaves a terrestrial cell set, the terrestrial cell set includes a reference cell, and the reference cell is a terrestrial cell that the terminal device currently camps on or accesses; and when the parameter information meets a first communication condition, the communication unit 601 is configured to obtain first communication information, where the first communication information is used to select a non-terrestrial cell, and the non-terrestrial cell is a non-terrestrial neighboring cell of the reference cell.

In a possible design, the terrestrial cell set further includes at least one terrestrial neighboring cell of the reference cell.

In a possible design, the processing unit 602 is further configured to obtain threshold information, where the threshold information is used to determine the first communication condition. The threshold information includes at least one of the following: a signal strength threshold, where the signal strength threshold is a threshold of signal strength detected by the terminal device; a first distance threshold, where the first distance threshold is a threshold of a distance between the terminal device and a reference location of the terrestrial cell set, and the terrestrial cell set includes the reference cell; a speed threshold, where the speed threshold is a threshold of a movement speed of the terminal device; a coordinate set of a target area, where the target area is determined based on a reference location of the reference cell and a part or all of a coverage area of the non-terrestrial cell, and the target area is in the reference cell; or a second distance threshold, where the second distance threshold is a threshold of a distance between the terminal device and a reference location of the non-terrestrial cell.

In a possible design, the parameter information includes the signal strength detected by the terminal device, and the first communication condition includes: The signal strength is less than or equal to the signal strength threshold.

In a possible design, the parameter information includes a first distance, the first distance is the distance between the terminal device and the reference location of the terrestrial cell set, and the first communication condition includes: The first distance is greater than the first distance threshold.

In a possible design, the parameter information includes the movement speed of the terminal device, and the first communication condition includes: The movement speed is greater than the speed threshold.

In a possible design, the parameter information includes location coordinates of the terminal device, and the first communication condition includes: The location coordinates are in the coordinate set of the target area.

In a possible design, the parameter information includes a second distance, the second distance is the distance between the terminal device and the reference location of the non-terrestrial cell, and the first communication condition includes: The second distance is less than the second distance threshold.

In a possible design, when the parameter information meets the first communication condition, the communication unit 601 is configured to monitor a system message from a first network device, where the first network device is a network device that manages the reference cell, and the system message includes the first communication information; or when the parameter information meets the first communication condition, the communication unit 601 is configured to send a distribution request to a second network device, and receive a distribution response from the second network device, where the distribution response includes the first communication information.

In a possible design, when the parameter information meets the first communication condition, the communication unit 601 is configured to monitor the system message from the first network device based on a target periodicity, where the target periodicity is greater than a sending periodicity of the first communication information.

In a possible design, the communication unit 601 is further configured to receive the sending periodicity of the first communication information.

In another possible example, the processing unit 602 is configured to send threshold information to a terminal device, where the threshold information is used to determine a first communication condition, and the first communication condition is used by the terminal device to determine whether to obtain first communication information; and the processing unit 602 is further configured to send the first communication information, where the first communication information is used to select a non-terrestrial cell, the non-terrestrial cell is a non-terrestrial neighboring cell of a reference cell, and the reference cell is a terrestrial cell that the terminal device currently camps on or accesses.

In a possible design, the threshold information includes at least one of the following: a signal strength threshold, where the signal strength threshold is a threshold of signal strength detected by the terminal device; a first distance threshold, where the first distance threshold is a threshold of a distance between the terminal device and a reference location of a terrestrial cell set, and the terrestrial cell set includes the reference cell; a speed threshold, where the speed threshold is a threshold of a movement speed of the terminal device; a coordinate set of a target area, where the target area is determined based on a reference location of the reference cell and a part or all of a coverage area of the non-terrestrial cell, and the target area is in the reference cell; or a second distance threshold, where the second distance threshold is a threshold of a distance between the terminal device and a reference location of the non-terrestrial cell.

In a possible design, the terrestrial cell set further includes at least one terrestrial neighboring cell of the reference cell.

In a possible design, the processing unit 602 is configured to send a system message, where the system message includes the first communication information; or the processing unit 602 is configured to receive a distribution request from the terminal device, and send a distribution response to the terminal device, where the distribution response includes the first communication information.

In a possible design, the processing unit 602 is further configured to send a sending periodicity of the first communication information to the terminal device, where the sending periodicity is used by the terminal device to determine a target periodicity of monitoring the system message.

Based on a same technical concept, an embodiment of this disclosure further provides another communication device. A communication device 700 may implement the communication method provided in the foregoing embodiments, and has a function of the communication apparatus 600 provided in the foregoing embodiments. Refer to FIG. 7. The communication device 700 includes a memory 702 and a processor 701. Optionally, the communication device 700 further includes a communication interface 703. The communication interface 703, the processor 701, and the memory 702 are connected to each other.

Optionally, the communication interface 703, the processor 701, and the memory 702 are connected to each other via a bus 704. The bus 704 may be a peripheral component interconnect (PCI) bus, an extended industry standard architecture (EISA) bus, or the like. The bus may be classified into an address bus, a data bus, a control bus, and the like. For ease of representation, only one bold line is used for representation in FIG. 7, but this does not mean that there is only one bus or only one type of bus.

The communication interface 703 is configured to receive and send signals, to implement communication with a device other than the communication device.

For a function of the processor 701, refer to the description in the foregoing embodiments. Details are not described herein again. The processor 701 may be a central processing unit (CPU), a network processor (NP), a combination of a CPU and an NP, or the like. The processor 701 may further include a hardware chip. The hardware chip may be an application-specific integrated circuit (ASIC), a programmable logic device (PLD), or a combination thereof. The PLD may be a complex programmable logic device (CPLD), a field-programmable logic gate array (FPGA), a generic array logic (GAL), or any combination thereof. The function may be implemented by the processor 701 by hardware. Certainly, the function may be implemented by hardware executing corresponding software.

The memory 702 is configured to store program instructions and the like. Specifically, the program instructions may include program code. The program code includes computer operation instructions. The memory 702 may include a random access memory (RAM), and may further include a non-volatile memory, for example, at least one magnetic disk memory. The processor 701 executes the program instructions stored in the memory 702, to implement the function, so as to implement the method provided in the foregoing embodiments. For example, the memory 702 may include the network device or the terminal device shown in embodiments of this disclosure.

Based on a same technical concept, an embodiment of this disclosure further provides a computer program. When the computer program is run on a computer, the computer is caused to perform the method provided in the foregoing embodiments.

Based on a same technical concept, an embodiment of this disclosure further provides a computer-readable storage medium. The computer-readable storage medium stores a computer program. When the computer program is run on a computer, the computer is caused to perform the method provided in the foregoing embodiments.

The storage medium may be any usable medium that can be accessed by the computer. The following provides an example but does not impose a limitation: The computer-readable medium may include a RAM, a ROM, an EEPROM, a CD-ROM, or another optical disc storage or disk storage medium, or another magnetic storage device, or any other medium that can carry or store expected program code in a form of an instruction or a data structure and can be accessed by the computer.

Based on a same technical concept, an embodiment of this disclosure further provides a chip. The chip is configured to read a computer program stored in a memory, to implement the method provided in the foregoing embodiments.

A person skilled in the art should understand that embodiments of this disclosure may be provided as a method, a system, or a computer program product. Therefore, this disclosure may use a form of hardware only embodiments, software only embodiments, or embodiments with a combination of software and hardware. In addition, this disclosure may use a form of a computer program product that is implemented on one or more computer-usable storage media (including but not limited to a disk memory, a CD-ROM, an optical memory, and the like) that include computer-usable program code.

This disclosure is described with reference to the flowcharts and/or block diagrams of the method, the device (system), and the computer program product according to this disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It is clear that a person skilled in the art can make various modifications and variations to this disclosure without departing from the scope of this disclosure. In this way, this disclosure is intended to cover these modifications and variations of this disclosure provided that they fall within the scope of the claims of this disclosure and their equivalent technologies.

What is claimed is:

1. A communication method, performed by a communication apparatus, the method comprising:
determining parameter information that is for determining whether the communication apparatus leaves a terrestrial cell set, the terrestrial cell set comprising a terrestrial cell that the communication apparatus currently camps on or accesses; and
obtaining first communication information when the parameter information meets a first communication condition, wherein the first communication information is for selecting a non-terrestrial cell that is a non-terrestrial neighboring cell of the terrestrial cell.

2. The method according to claim 1, the method further comprising:
obtaining threshold information that is for determining the first communication condition, the threshold information comprising at least one of the following:
a signal strength threshold of a signal strength detected by the communication apparatus;
a first distance threshold of a distance between the communication apparatus and a reference location of the terrestrial cell set, the terrestrial cell set comprising the terrestrial cell;
a speed threshold of a movement speed of the communication apparatus;
a coordinate set of a target area in the terrestrial cell, the target area being determined based on a reference location of the terrestrial cell and a part or all of a coverage area of the non-terrestrial cell; or
a second distance threshold of a distance between the communication apparatus and a reference location of the non-terrestrial cell.

3. The method according to claim 2, wherein the parameter information comprises the signal strength detected by the communication apparatus, and the first communication condition comprises: the signal strength is less than or equal to the signal strength threshold.

4. The method according to claim 2, wherein the parameter information comprises a first distance, the first distance is the distance between the communication apparatus and the reference location of the terrestrial cell set, and the first communication condition comprises: the first distance is greater than the first distance threshold.

5. The method according to claim 2, wherein the parameter information comprises location coordinates of the communication apparatus, and the first communication condition comprises: the location coordinates are in the coordinate set of the target area.

6. The method according to claim 2, wherein the parameter information comprises a second distance, the second distance is the distance between the communication apparatus and the reference location of the non-terrestrial cell, and the first communication condition comprises: the second distance is less than the second distance threshold.

7. The method according to claim 1, wherein the obtaining the first communication information when the parameter information meets the first communication condition comprises:
monitoring a system message from a first network device when the parameter information meets the first communication condition, wherein the first network device is a network device that manages the terrestrial cell, and the system message comprises the first communication information; or
sending a distribution request to a second network device when the parameter information meets the first communication condition, and receiving a distribution response from the second network device, wherein the distribution response comprises the first communication information.

8. A communication apparatus, comprising:
at least one processor coupled to one or more memories and executing programming instructions stored in the one or more memories to cause the communication apparatus to perform operations including:
determining parameter information that is for determining whether the communication apparatus leaves a terrestrial cell set, the terrestrial cell set comprising a terrestrial cell that the communication apparatus currently camps on or accesses; and
obtaining first communication information when the parameter information meets a first communication condition, wherein the first communication information is for selecting a non-terrestrial cell that is a non-terrestrial neighboring cell of the terrestrial cell.

9. The communication apparatus according to claim 8, wherein the operations further include:
obtaining threshold information that is for determining the first communication condition, and the threshold information comprising at least one of the following:
a signal strength threshold of a signal strength detected by the communication apparatus;
a first distance threshold of a distance between the communication apparatus and a reference location of the terrestrial cell set, and the terrestrial cell set comprises the terrestrial cell;
a speed threshold of a movement speed of the communication apparatus;
a coordinate set of a target area in the terrestrial cell, the target area being determined based on a reference location of the terrestrial cell and a part or all of a coverage area of the non-terrestrial cell; or
a second distance threshold of a distance between the communication apparatus and a reference location of the non-terrestrial cell.

10. The communication apparatus according to claim 9, wherein the parameter information comprises the signal strength detected by the communication apparatus, and the first communication condition comprises: the signal strength is less than or equal to the signal strength threshold.

11. The communication apparatus according to claim 9, wherein the parameter information comprises a first distance, the first distance is the distance between the communication apparatus and the reference location of the terrestrial cell set, and the first communication condition comprises: the first distance is greater than the first distance threshold.

12. The communication apparatus according to claim 9, wherein the parameter information comprises location coordinates of the communication apparatus, and the first communication condition comprises: the location coordinates are in the coordinate set of the target area.

13. The communication apparatus according to claim 9, wherein the parameter information comprises a second distance, the second distance is the distance between the communication apparatus and the reference location of the non-terrestrial cell, and the first communication condition comprises: the second distance is less than the second distance threshold.

14. The communication apparatus according to claim 8, wherein the operations further include:
monitoring a system message from a first network device when the parameter information meets the first communication condition, wherein the first network device is a network device that manages the terrestrial cell, and the system message comprises the first communication information; or
sending a distribution request to a second network device when the parameter information meets the first communication condition, and receiving a distribution response from the second network device, wherein the distribution response comprises the first communication information.

15. A non-transitory computer-readable storage medium storing computer instructions that, when executed by a communication apparatus, cause the communication apparatus to perform operations including:
determining parameter information that is for determining whether the communication apparatus leaves a terrestrial cell set, the terrestrial cell set comprising a terrestrial cell that the communication apparatus currently camps on or accesses; and
obtaining first communication information when the parameter information meets a first communication condition, wherein the first communication information is for selecting a non-terrestrial cell that is a non-terrestrial neighboring cell of the terrestrial cell.

16. The non-transitory computer-readable storage medium according to claim 15, wherein the operations further include:
obtaining threshold information that is for determining the first communication condition, and the threshold information comprising at least one of the following:
a signal strength threshold of a signal strength detected by the communication apparatus;
a first distance threshold of a distance between the communication apparatus and a reference location of the terrestrial cell set, and the terrestrial cell set comprises the terrestrial cell;
a speed threshold of a movement speed of the communication apparatus;
a coordinate set of a target area in the terrestrial cell, the target area being determined based on a reference location of the terrestrial cell and a part or all of a coverage area of the non-terrestrial cell; or
a second distance threshold of a distance between the communication apparatus and a reference location of the non-terrestrial cell.

17. The non-transitory computer-readable storage medium according to claim 16, wherein the parameter information comprises the signal strength detected by the communication apparatus, and the first communication condition comprises: the signal strength is less than or equal to the signal strength threshold.

18. The non-transitory computer-readable storage medium according to claim 16, wherein the parameter information comprises a first distance, the first distance is the distance between the communication apparatus and the reference location of the terrestrial cell set, and the first communication condition comprises: the first distance is greater than the first distance threshold.

19. The non-transitory computer-readable storage medium according to claim 16, wherein the parameter information comprises location coordinates of the communication apparatus, and the first communication condition comprises: the location coordinates are in the coordinate set of the target area.

20. The non-transitory computer-readable storage medium according to claim 16, wherein the parameter information comprises a second distance, the second distance is the distance between the communication apparatus and the reference location of the non-terrestrial cell, and the first communication condition comprises: the second distance is less than the second distance threshold.
